(19) United States
(12) Patent Application Publication
(10) Pub. No.: US 2007/0255803 A1
(43) Pub. Date: Nov. 1, 2007

(54) X-MAIL (TM)

(76) Inventor: GABE CHERIAN, Sun Valley, ID (US)

Correspondence Address: GABE CHERIAN, P.O. BOX 1335, SUN VALLEY, ID, 83353, US

(21) Appl. No.: 11/740,868

(22) Filed: Apr. 26, 2007

Related U.S. Application Data
(60) Provisional application No. 60/795,904, filed on Apr. 28, 2006.

(51) Int. Cl. G06F 15/16

(52) U.S. Cl. 709/217

(57) ABSTRACT

The invention covers certain improvements to the Internet methods of handling “stray” email messages, which are sent to old “invalid” email addresses. It provides means and methods to salvage such stray messages. It proposes to establish a depository center, to store information in database files, to be referred to as the XMAIL™ Database, correlating old “invalid” addresses of participating users to their corresponding new “valid” addresses. Also a new host computer, to be referred to as the XMAIL™, would be created to handle the XMAIL™ Database and the stray mail procedure. On demand and according to the wishes of the participants, the XMAIL™ center can provide the necessary information to help in forwarding/delivering such stray messages to their intended recipients. Also on demand, the new addresses can be given to, or withheld from, the senders, to honor the wishes of the participating recipients. The proposed system can lead to creating what could be called a Universal Email Address or a Universal ID System.

### CROSS-REFERENCE TO RELATED APPLICATIONS

This application is a NON-PROVISIONAL UTILITY PATENT APPLICATION, and it is claiming the priority and benefits of Provisional Patent Application Ser. No. 60/795,904, filed Apr. 28, 2006, entitled “X-MAIL™”, which is incorporated herein in its entirety by reference.

### OTHER REFERENCES

Book References:

Ref1—SENDMAIL, 2^{nd} Edition, by Bryan Costales & Eric Allman, 2^{nd} Edition January 1997, 1050 pages, ISBN 1-56592-222-0

Ref2—SENDMAIL, THEORY AND PRACTICE, by Frederick M. Avolio and Paul A. Vixie, \textcircled{C}1995 Butterworth-Heinemann, Digital Press, ISBN 1-55558-127-7.

Ref3—DNS and BIND, 3^{rd} Edition, by Paul Albitz & Cricket Liu, Printed September 1998, \textcircled{C}1998, 1997, 1992 O'Reilly & Associates, O'Reilly, ISBN 1-56592-512-2.

Ref4—SENDMAIL, Desktop Reference, by Bryan Costales & Eric Allman, \textcircled{C}1997 O'Reilly & Associates, O'Reilly, ISBN 1-56592-278-6.

These books cover very nicely the subject technology addressed in this application. I have used them to learn about the technology and how the Internet works and how email messages are handled on the Internet.

I have also copied several figures from Ref2 and Ref3 and inserted them into this application, as indicated in my Figures or elsewhere in this specification, to show the Prior Art, from which I have started and to which I am proposing certain changes/improvements as explained in this application.

I would like to recognize the authors and publishers of these books and to acknowledge their work, and to show my appreciation to their contributions in this field.

### STATEMENT REGARDING FEDERALLY SPONSORED RESEARCH OR DEVELOPMENT

Not Applicable

### REFERENCE TO A MICROFICHE APPENDIX

Not Applicable

Trademarks, Trade Names

The inventor, Gabe Cherian, has used some of the following trade marks and/or trade names, and would like to use or at least reserve all them:

EMAIL CENTRALE™, (EC™),

EMAIL CENTRAL™, (EC™),

EMAIL EXCHANGE™, (EE™),

EMAIL HUBTM™, (EH™),

EMAIL NAME EXCHANGE™, (ENE™),

EMAIL NAME RETRIEVAL™, (ENE™),

EMAIL SWITCH STATION™, (ESS™),

MAIL CENTRALE™, (MC™),

MAIL CENTRAL™, (MC™),

MAIL EXCHANGE™, (ME™),

MAIL HUB™, (MH™),

MAIL NAME EXCHANGE™, (ENE™),

MAIL NAME RETRIEVAL™, (ENE™),

MAIL SWITCH STATION™, (MSS™),

NAME EXCHANGE™, (NE™),

NAME RETRIEVAL™, (NE™),

STRAY EMAIL™, (ESM™),

STRAY MAIL™, (SM™),

THE-HUB™, (TH™),

XMAIL™,

XMAIL™,

X-MAIL™,

X-MAIL™,

XML1™,

X-ML1™,

XML™,

XML™,

X-ML™,

XM™,

X-M™,

Legends:

The following legends will be used synonymously and interchangeably within this specification. They will be used to represent the methods and systems covered by the present patent application here.

XMAIL™, XMAIL™, X-MAIL™, XML1™, X-ML1™, XML™, XML™, X-ML™, XM™, X-M™.

Definitions

For the purpose of the following invention description and specification, I will use certain words or terms that may be peculiar to this application. They will be explained in the following definitions, or as I go along during the application.

Beside the Ref #s, I will sometimes use the following legend to identify certain parts, items, issues and/or concepts, although this may be superfluous.

See Specification for the definitions of the following terms:

DNS

Email

Email message

Host Computer

Internet

Name Server

Node

Recipient

Resolver

RFC

Sender

Server Client

Stray email message

Other Definitions:

DNS Domain Name Service

BIND Berkeley Internet Name Domain

### BACKGROUND OF THE INVENTION

### Field of the Invention

The present invention relates generally to email messages, which are handled on the Internet. More particularly, it relates to “stray” email messages [Definition] that are sent out by “senders”, where the sender has used an “old” email address of the recipient, and/or where the email address of the “recipient” is considered “not valid” any more. Like in the case of where the Recipient had changed his/her email address, and the Sender is not aware of the change. Then the email message cannot be delivered to its destined recipient.

The invention also relates to the problem of having the messages returned to the sender as “undeliverable”, and/or loosing these stray messages in the system, which results in possibly loosing the connection between the sender and the recipient.

The invention further relates to and proposes ways to correct the situation and to avoid such a loss and to provide means, systems and methods, which can help in salvaging such stray messages and “optionally” in re-connecting the users on the Internet.

The invention can also be extended and applied to other fields or activities, where items are handled back and forth, such as parcels and packages, which are handled by the US Postal Service, FEDEX, UPS and the like.

### OBJECTIVE OF THE INVENTION

To salvage stray email messages, whenever a message is sent to an old invalid email address and to redirect such messages to their correct recipients. And depending on the options selected by the participants in the system, the new/valid email address of the recipient can be communicated to the sender. Other options can be selected as well.

Another objective is to provide the above services on a continuous basis, not for a period of 6 months or so, like some ISP do when they force their clients to change their email addresses, and it would not be cut-off at the whims of the ISP, but at the pleasure of the participating users. In other words, this would be a stand-alone commercial business providing the services described here.

The proposed methods, services, systems, etc. would lead to the establishment of “Universal Email Addresses” or “Universal IDs” for the participating users.

### BACKGROUND

Background, Existing Problem and the Need for a Better Way.

When an Internet user (recipient), who receives email messages from others (senders), changes his/her email address, the new address is usually not known right away to the senders, i.e. the people who have known the user under his/her old recipient address. So, if one of those senders sends a message to the old address of the recipient, the message is usually returned to the sender with a notation, stating in essence that the message is “undeliverable”, because the address used is “invalid”. Typical expressions received in such cases are: “Returned Mail” or “User Unknown”.

The sender will have no easy way to know the new address of the recipient and consequently, the connection between the sender and the recipient may become forever “dead” and “lost”.

I'd like to define mail in such situations as “STRAY MAIL” or “Stray Email Messages on the Internet”

There are a few ways to solve the problem and save the situation.

One obvious way is that the user/recipient would inform the sender of his/her new address. This is easy to say. In fact, it is a horrendous task for a recipient to inform all his senders, about his change of address. It could be pretty time consuming to the Recipient. And for the most part, it would be pretty difficult to approach each and everyone, who should be notified. Sometimes, it is pretty impractical and many times impossible to do that.

Another way, is for the sender to contact the recipient in a different way and to get his/her new email address, for example by calling the recipient on the phone or by sending a letter through the US Postal Service or the like. But that is also inconvenient and time consuming to the sender.

The most probable end result is that the connection between the sender and the recipient is either damaged or lost forever.

However, in some cases, the change of the address is done deliberately, for example to become unknown/incognito to certain senders in order to reduce the amount of undesirable SPAM that a Recipient had been receiving. In such a case, the Recipient is happy that the Senders do not know his NEW email address and would very much like that they do not get to know it at all.

Personal Experience

I, the inventor, went through several (Internet life) stages, where I have experienced similar problems with my email addresses. I will summarize here briefly the major stages, using some fictitious names for the Internet Service Providers (ISPs).

Stage 1. Since the beginning of time when email messages first became available to the general public, I was employed by “Rara Company” in California. Rara Co provided me with the capability of having emails, and my email address was “gcherian@rara.com”.

Stage 2. In 1996, I retired and moved to Idaho. I had to find a new ISP. I found the ISP, “Mimi Company”. So, I got a new email address, which was “gcherian@mimi.net”. This was using the telephone wires and it was slow, but it was the best system speed available at that time. Of course, I had no choice and I informed many of my friends about my new email address, but I am sure that I have lost some of my old friends and contacts.

Stage 3. A couple of years later, Mimi Company decided to get out of the ISP business and of providing Internet and email service. However, they were nice enough to offer their customers a substitute ISP. It was “Didi Company”. Didi Company was also using the telephone wires and had a similar “slow” speed. And I would be forced to change my email address to “gcherian@didi.com” or the like.

However, by that time, another local ISP, “Coco Company”, was offering a high speed connection using the fiber optic cables that they were using to provide the TV service. So, I opted to go with Coco Company and my email address became “gcherian@coco-internet.com”. Since I had to change my email address anyways, I figured I might as well enjoy the “high speed” service provided by Coco Company. Of course one more time, I had no choice and I informed many of my friends about my new email address. But again, I am sure that I have lost a few more of my old contacts.

Stage 4. A few more years later, Coco Company decided to change their email identification from @ coco -internet.com to @ coco.net. So, my new email address had to change and became “gcherian@coco.net”. This time, Coco Company was nice enough to “forward” my incoming email messages, which were sent using my old address, i.e. gcherian@coco-internet.com, to me at my new email address, i.e. gcherian@coco.net.

However, this forwarding service was made available for six (6) months only. I was expected to notify ALL my contacts about my change of address during those six months. After that, any email address sent to me using my old @coco-internet.com was lost. It was probably returned to the sender, saying that his message is “undeliverable” because the email address he used is “invalid”.

Stage 5. A couple of years ago, my wife and I purchase a second home in Utah and started to “snow-bird” between Idaho in the summer and Utah in the winter. The ISP at the house in Idaho does not operate in the area of the house in Utah. So, I had to find a new ISP in Utah. I found the Chacha Company”. My email address with the Chacha Company became “gcherian@chacha.com”. So, now I had two active email addresses. Fine. But I did not inform my contacts about this latest address. Whenever I moved from Idaho to Utah or vice versa, I had the choice of either switching my email addresses back and forth, or of keeping both addresses and paying for two ISP services to keep the two email addresses alive all the time. So, I kept both addresses for a while. The other choice would have been a pain.

Stage 6. About a year ago, the Chacha Company changed its name, or actually was acquired by Gege Company. My email address would have changed to “gcherian@gege.com”. By that time, I had enough of all these changes. So, I decided to have a new email connection via a “portable” email address, such as “gcherian@yaya.com”. I am hoping that this will be a more permanent email address and I am in the process of informing my contacts about this latest change.

Stage 7. A month ago, I was informed that Gege Company either decided to change its name voluntarily or was acquired by “Bebe Company”. I would have had to change my email address to “gcherian@bebe.com”. Thank God, I will not do that. I will have that email address as far as the ISP Company is concerned, but I will not send out any messages using this latest address, so that my contacts will never find out about it. I will use my gcherian@yaya.com address exclusively from now on, so that my contacts will respond to it, and to it alone.

In between, I had a short bout or two with aol.com and the like. And of course every time, I had to have email addresses to match.

On one hand, this creates a lot of headaches, extra work and losses of contacts. On the other hand, there is one big advantage. Every time I changed my email address, I got fewer SPAM messages. This is a blessing. Generally, I used to get somewhere up to 50 SPAM messages a day. Every time my email address changed, the number of SPAM messages drop to zero, but the SPAM messages gradually and mysteriously would start to sprout out again.

What a story.

However, I am sure that I am not alone. I am sure that there are thousands, if not millions, of other users, who experience such and similar situations as I have gone through. My question is “why should I go through such a headache?” and “why should anybody else go through such a headache?”. There should be a better way. And this better way is what I am proposing by this present invention here.

I did find an easier/better way to overcome this problem and to avoid all these difficulties. I am describing it in this patent application. I can call it by different names, such as “Email Switch Station” (ESS), or simply “Mail Switch Station” (MSS) or “Mail Centrale” (MS) or “STRAY MAIL” (SM) or “X-Mail”™, “Xmail”™, “XMail”™, “XML”™, and the like. I will refer to it as XML1 in the rest of the specification here.

It is a Method and a Software Program and a System, a Method of using that program to deliver such stray mail to its proper recipient at the proper destination and according to the will and wishes of the recipient.

Similar problems occurred when I changed my telephone numbers, when I moved from one town to another. And similar methods as proposed herein can be used and applied for those telephone numbers as well, for land-line telephones and even for cell phones.

The purpose of this new invention here is to overcome the above difficulties and optionally to keep any benefits that exist with the present situation.

### THE INVENTION

The purpose of this new invention here is to overcome the difficulties mentioned above.

In brief, the invention's main objective is to create an automatic method of redirecting the so-called “undeliverable” or “stray” email messages to the new address. A second objective is to alert the recipient user that a “redirection” has occurred. A third objective is to notify the sender(s) about the new address for future use, either automatically or optionally, if the recipient wishes that this be done.

The method of accomplishing these objectives is described here below.

Prior Art-1—Patent Search

I could not find any Prior Art Patents that teach what I am proposing here in the present Patent Application here. I found the two following patents, which teach something close, but not close enough to make them obstacles against my proposed inventions.

1. U.S. Pat. No. 6,064,981 to Barni et al., Method for online display and negotiation of cargo rates.

2. U.S. Pat. No. 36,070,147 to Harms et al., Customer identification and marketing analysis systems.

PRIOR ART-2—A New System on the Market.

Just a few days ago, I heard about a new website called “Grand Central”, “http://www.grandcentral.com/”. It offers something similar to what I am proposing here, but it works with telephone numbers only. It does not address the issues with Emails on the Internet. I do not know what patent coverage they have. But, it proves that there is a need for a system like the one I am proposing here.

PRIOR ART-3—How the Present System Works

I will first describe how the present system works, based on what I have learned from reading the Reference Books listed above and from a few other sources. Then further down below, I will describe my proposed solutions.

Existing/Present Method of Delivering Email Messages:

The Internet is a fairly complex system. Its protocols and functions are based on various rules, methods and systems, which make the whole Internet function as smoothly as it does. I will highlight just a few of those methods to explain the essential features, which will ultimately lead to my proposed changes and improvements.

DOMAINS AND SUBDOMAINS. An extremely large volume of email messages and Internet traffic is handled on the Internet by what is called host computers, which are referred to also as clients and servers. These computers are grouped, organized and named in a specific fashion as shown in FIGS. 1-4. There are several methods of organizing and naming these host computers. It seems that the ones that are used most are: 1) DNS database method, 2) UNIX filesystem method, and 3) The ARPA Domain method, as in FIGS. 1-4.

NAMING METHODS. The naming format in each of these methods is slightly different, but basically they all have the same approach and end goal. They use a hierarchical approach, with several levels or tiers, called domain and subdomains, and the naming is done so as to make it easy to locate any specific host computer. It looks like a genealogical tree.

An example could be the name “winnie.corp.hp.com” for a specific computer, as shown in FIG. 3 and in the left side of FIG. 4. This is a “hierarchical” way of calling names. It is similar to a genealogical tree. I would call this method a “bottom up” or ascending method. Here, “winnie” is a computer node under the node “corp”, which is under the node “hp”, which is under the node “com”, which is under the “root” node. This is the DNS database method

The right side of FIG. 4 shows an example of the UNIX filesystem method. I would call it the “top down” or descending method.

A similar method is used for naming individual users. For example, a name for a specific user, say for Mr. Albert Einstein, who is connected with UC Berkeley, could be “aeinstein@berkeley.edu”, where “aeinstein’ is the name of the user, who is “reachable” at the node “berkeley”, which is under the node “edu”, which is understood to be under the “root” node.

SENDMAIL. The traffic of email messages on the Internet is handled by specific programs. See FIG. 5. The following names can be seen: SMTP, Mail11, uux rmail, uuxqt rmail, Mail, MH(XMH), Elm. But the focal point is the program called Sendmail.

SENDMAIL is used to facilitate and to control the procedures and rules of transferring email messages between senders and recipients. A lot of the procedures and “rules” are described in documents called “RFC”, which stands for “Request For Comments”. Some of the most important RFCs, which relate to email transfer, are RFC821, RFC822, RFC819, RFC976, RFC1123, RFC1521, RFC1522, RFC1651, RFC1652, RFC1653, RFC1891, RFC1892, RFC1893, and RFC1894. See Reference Book #1 and #2. I am sure that more RFCs are still being generated.

THE RESOLUTION PROCESS. The way an email message is transferred from one computer (Sender) to another computer (Recipient) is illustrated in FIG. 6. The figure shows an example of how to find the location of the host computer of the Recipient User named “girigiri.gbrmpa.gov.au”.

The Sender computer needs to know which Recipient Computer is hosting this Recipient User. So, the Sender computer uses a “Resolver” to do that. In FIG. 6, we can see that the Sender computer is called the Client and is acting as the Resolver.

The Resolver sends a query (1) to a Local name server.

The local name server sends a query (2) to the Root name server. The Root name server sends an answer to query (2) to the Local name server, referring it to the “au” name server. So now, the local name server has located the first level name server, which handles the “au” part of the Recipient User name.

Then, the local name server repeats the process to locate the next level server down. It sends another query (3) to the “au” name server. The “au” name server sends an answer to query (3) to the Local name server, referring it to the “gov” name server. So, now the local name server has located the second level name server, which handles the “gov.au” part of the Recipient User name.

Again, the local name server repeats the process to locate the next level server down. It sends another query (4) to the “gov.au” name server. The “gov.au” name server sends an answer to query (4) to the Local name server, referring it to the “gbrmpa.gov.au” name server. So, now the local name server has located the third level name server, which handles the “gbrmpa.gov.au” part of the Recipient User name.

One last time, the local name server repeats the process to locate the next level server down. It sends another query (5) to the “gbrmpa.gov.au” name server. The “gbrmpa.gov.au” name server sends an answer to query (5) to the Local name server, giving it the full address of the recipient, which is “girigiri.gbrmpa.gov.au”.

Now the Local Name Server has the full address and knows where the recipient is, it sends an answer (6) to the Client Resolver informing it of the exact location and address of the recipient. Now it is up to the Client to send the message to his recipient.

FIG. 7 shows the resolution process in a different way. It shows A as the Local Name Server of FIG. 6, and B, C, and D as some of the other Name Servers of FIG. 6. Basically, it is an iterative process, going down the hierarchy line, resolving for the segments of the email address one step after the other, as explained above for FIG. 7.

FIG. 8 shows another example, where the system is resolving for “baobab.cs.berkeley.edu”. I guess now, it is clear how the system works.

SUMMARY. So, in summary, the search to establish the connection follows the hierarchical names, going from the top node and proceeding to the lower nodes, one step at a time, as illustrated very nicely in these 3 figures, FIGS. 6 through 8.

NECESSARY NAMES COMPONENTS. For this reason, when a message is sent to a certain recipient, the message should have the address of the recipient. Recipients' names have the format that facilitates in locating the specific recipient. First, you need to give the user's own name and then you need to give a name of the host computer/server, which hosts this specific.

The Problem.

The problem occurs, when an email message is sent to an address that is not valid anymore, the system does not know where to send the message. The system attempts to re-send the message a few times. If the attempts fail, then the message is forwarded to a place, which sends a “Mailer-Daemon” message to the sender, informing the sender that the message is “undeliverable”, because the address is “invalid”.

Ultimately the message is discarded by the system.

It is then up to the sender to search and attempt to find a “valid” address of the recipient and then send his message to the newly found address, or he/she despairs and abandons all attempts.

### SUMMARY OF THE INVENTION

My Proposed Solution:

I would establish a sort of an “email exchange station” or an “email address exchange station”, or better yet a “universal email station” and/or an independent “email ISP”.

I would create database files, which would contain old “invalid” addresses of users together with their corresponding “valid” addresses. I would place/store these database files in a repository storage, like a “server” computer. I would give this computer an appropriate name, such as “XMAIL™”. Other possible names could be “EMAIL-EXCHANGE™”, “NAME-EXCHANGE™”, “THE-HUB™”, “EMAIL HUB™, “EMAIL CENTRAL™”, or the like.

Whenever necessary, the SENDMAIL program and any other related Internet program or the like, would be modified and/or re-configured, so that it would “divert” or “redirect” or “forward” all “undeliverable” and/or “stray” messages to my “XMAIL™” server. XMAIL™ would in turn give out, as the required “answer”, the correct “valid” address that corresponds to the so-called “invalid” address in each specific message, so that the message could be delivered to the appropriate receiver.

Of course, there could be cases where XMAIL™ will not have the appropriate information in its database files, in which case the system would digress to the old method of Mailer-Daemon notification to the sender.

The system will also provide several options to the “subscribers” including at least the following:

1. Establish a permanent email address,

2. Use XML1 as their direct ISP and their permanent “email home”,

3. Whether to notify or not to notify the Sender of the new address of the Recipient,

4. Whether the Recipient would be notified or not notified about the fact that the Sender did not know the new address,

5. Recipient will instruct XML not to forward the message, but to be notified about it and then Recipient to decide whether to obtain it or to delete it,

etc.

### BRIEF DESCRIPTION OF THE DRAWINGS.

FIGS. 1-8 show the Prior Art, i.e. the present way the email messages are handled on the Internet, and the reasoning behind the formats of users' names and servers' names.

FIG. 9 shows the situation when the XML node is introduced in the Internet system, and the two additional query/answer steps that will be added to the Resolution procedure.

FIG. 10 shows how XML node could fit into the Internet scheme of node. In this case, the XML node is immediately under the root node.

FIG. 11 shows a different way of how XML node could fit into the Internet scheme of node. In this case, the XML node is as a lower level node. In this case it is under a top level node, such as a “.com” node.

FIG. 12 shows schematic flow chart of how the introduction of XML into the Internet system would affect the information about old and new email addresses and the flow of email messages.

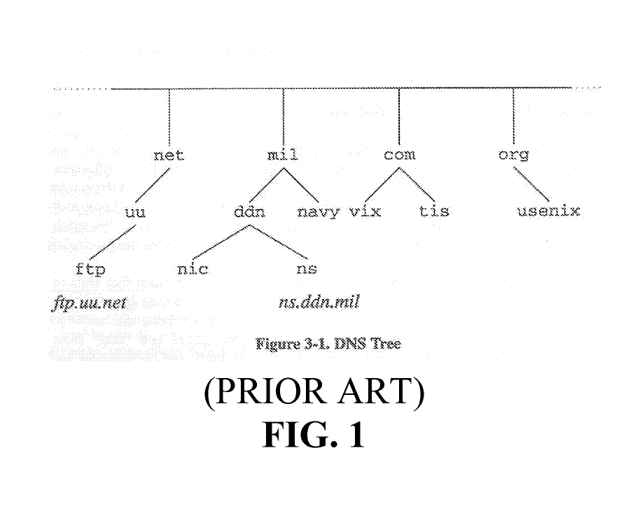

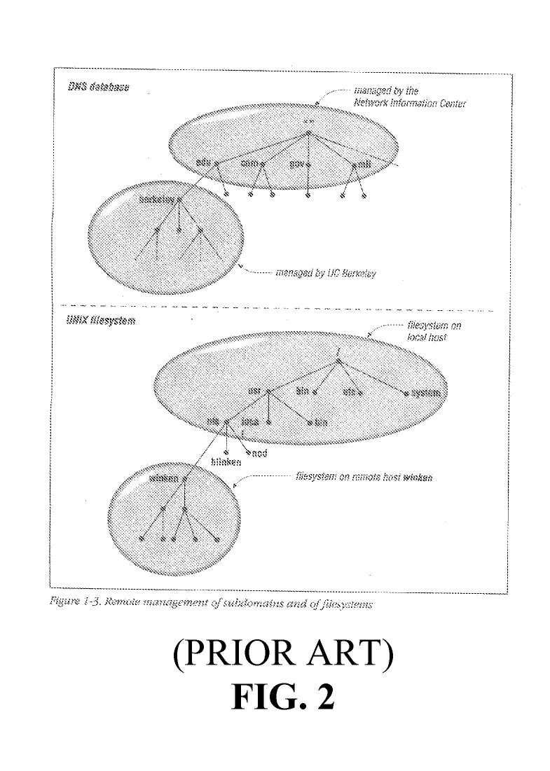

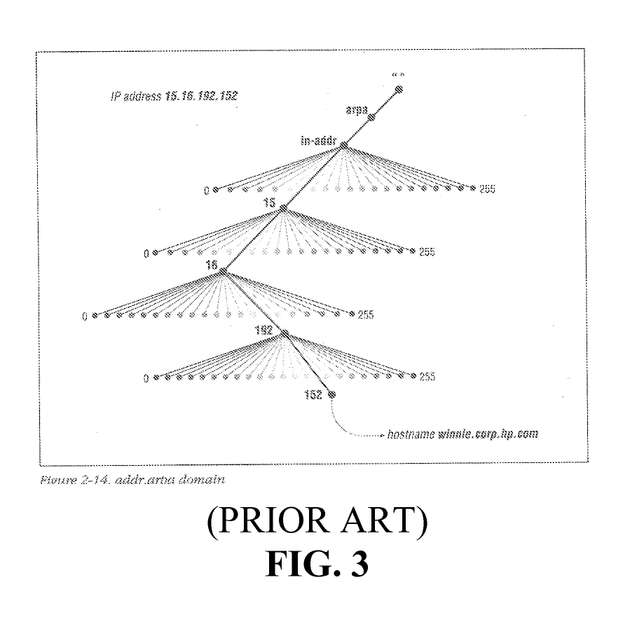

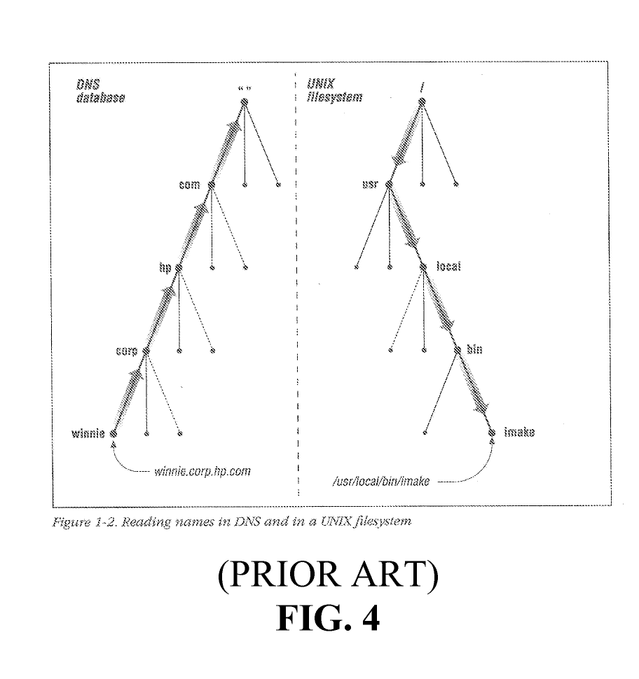

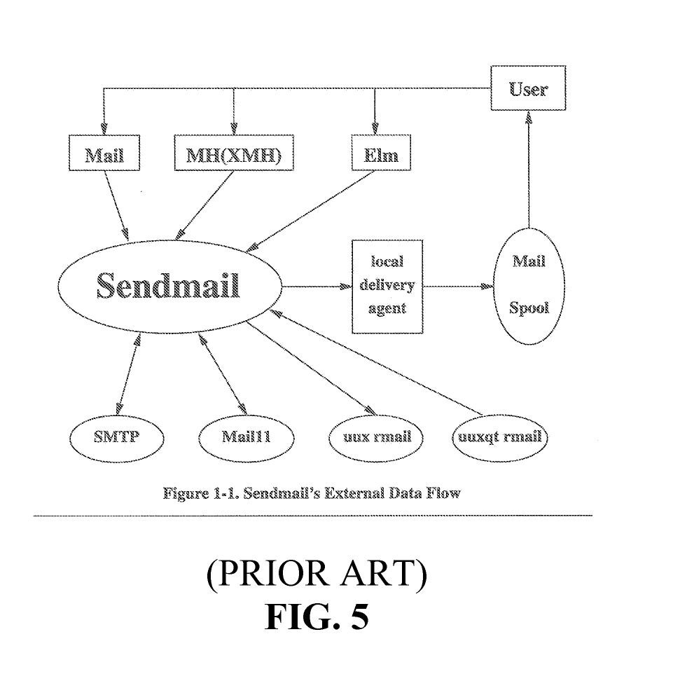

### DETAILED DESCRIPTION OF THE INVENTION.

As mentioned earlier in the summary, there are several inventions here. I will describe them as we go along. I will however group them into individual groups. The specifications will cover all these groups of inventions.

Benefits of the Proposed Invention to the Internet Email World:

The proposed service will salvage stray email messages on the Internet, will preserve the interconnectability between Senders and Recipients, and will generally facilitate the “mobility” of Internet Email users.

Users need to change their email addresses from time to time. They may relocate to another town that is not serviced by their old Internet Service Provider (ISP), or they may not be satisfied with one ISP and may like to utilize the services of another. Or they may simply like to control the amount of SPAM, that comes to them and obtain a new email address, which would not be known to the old SPAM senders. By subscribing to our “XMAIL™” service, Recipient users become assured that their “selected” email correspondence to any of their old addresses will continue uninterrupted. Same service can be provided to groups of subscribers and/or to ISPs as well.

Logistics:

We, or any authorized provider of the proposed service, would make it known to the Internet users' world, that this service is available to them. Any particular user would be able to partake or subscribe to the service, for a fee. They may opt to use the service for a few weeks, a few months or for any time duration that they feel would be necessary for their particular transition situation.

We would also make the service known to the Internet Service Providers (ISPs). Our service will be of special interest to any ISP, who is promoting and trying to expand his business. The ISP can offer to provide our forwarding service at no charge to their prospective customers, explaining that there will be no interruption in their mail flow even if they switch from an old ISP.

Mechanics: See Figs. Xx ss xxx. Ref#s.

The way to make all this happen is a simple “IF . . . Then . . . ” statement that can be added into the “SENDMAIL” program. IF the program encounters a case of “undeliverable” message, THEN the program's IF statement would tell the system to (1) forward the message to the “XMAIL™” server. The XMAIL™ server would lookup/“query” the old/invalid address in the database files, find the new valid address and (2) provide it to the system, by giving the “answer” in reply to the query. The system would “rewrite” the name of the recipient and deliver the message. This would satisfy the first objective of this invention.

An optional additional feature would be to notify the sender of the whole story. This can happen before sending the message to the recipient, thus giving the sender the option to verify the new address before sending the message. Or this can happen after redirecting and sending the message, simply to inform the sender of what happened and giving him/her the new address for future use. This would satisfy the second objective of this invention.

Another option would be to add a notification to the delivered message, alerting the recipient that a “redirection” has taken place, so that the recipient could take whatever appropriate action he/she may feel necessary. This would satisfy another one of the objectives of this invention.

Of course if the old address and its corresponding new address are not in the database files, then XMAIL™ will notify the system of this fact and the system would go back to the “Mailer-Daemon” and proceed as in the past.

One of the most desirable options is to subscribe directly to XMAIL™ and use it as the principal ISP for the user.

Security:

A lot of safeguards would be in place to prevent unauthorized misuse of, or tampering with, the system. For example, the user would have to check and recheck the correctness of his old and new addresses. The XMAIL™ system will also check a number of “identifiers” to ascertain the authenticity and legitimacy of the inputs and ensure that no “malicious” entries are accepted into the database files.

### DESCRIPTION OF THE PREFERRED EMBODIMENTS

While the invention is susceptible of various modifications and alternative constructions, certain illustrative embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as described in the Specification and as defined in the claims.

While I am describing the drawing in more details, I will at the same time explain the technology basis of the invention. I will also include a number of examples in this section, which should be considered as part of the embodiments for the purpose of this application as well.

This description covers more than one invention. The inventions are based partly on the same technology platform, but then each of the inventions has some additional features of its own. Not being an expert in handling patents, I would like to leave it to the patent examiner to decide on the number of the inventions contained and how to split one invention from the other.

When referring to the preferred embodiments, certain terminology will be utilized for the sake of clarity. Use of such terminology is intended to encompass not only the described embodiment, but also technical equivalents which operate and function in substantially the same way to bring about the same result.

It should of course be understood that the description and drawings herein are merely illustrative and that various modifications and changed can be made in the methods and systems disclosed without departing from the spirit of the invention.

Many of the steps, methods and procedures mentioned herein are based on normal ones already established and being used in the present Internet world. The selective use of these steps, methods, procedures and systems is what makes the invention what it is. Any individual well versed in the art and field being addressed would know how what needs to be done to implement them, based on the descriptions and explanations given in this specification.

I will use the following example to illustrate how the present old system operates and how the proposed improved system will operate. I will use the case of the user Mr. Albert Einstein. A partially similar example was given in one of the reference books listed above.

Let us say that Mr. Albert Einstein was at UC Berkeley and his email address was “aeinstein@berkeley.edu”. Let's say that Mr. Einstein moves to Boston to join MIT. He changes his email address to “aeinstein@mit.edu”.

Now, we can visualize two scenarios: First, what would happen if we still have the present system, as is. Second, what would happen if we adopt XMAIL™, according to this invention?

1. Present Old System:

Let's say that a third party user, Mr. Pablo Picasso, Sender, sends an email message to Mr. Einstein, Recipient, at his old address “aeinstein@berkeley.edu”. According to the way the present system is configured now, when the message reaches the host computer at UC Berkeley, the message would be rejected, because such a name is no more an active name in its database files. After a few such attempts, the system will return the message to the Sender, Mr. Picasso, informing him that the message is “undeliverable”, because the address is “invalid”.

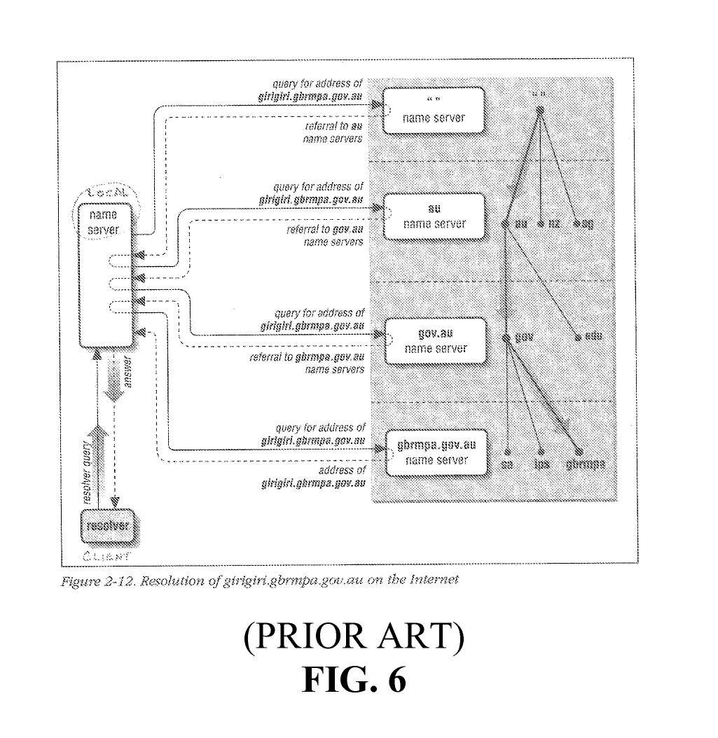

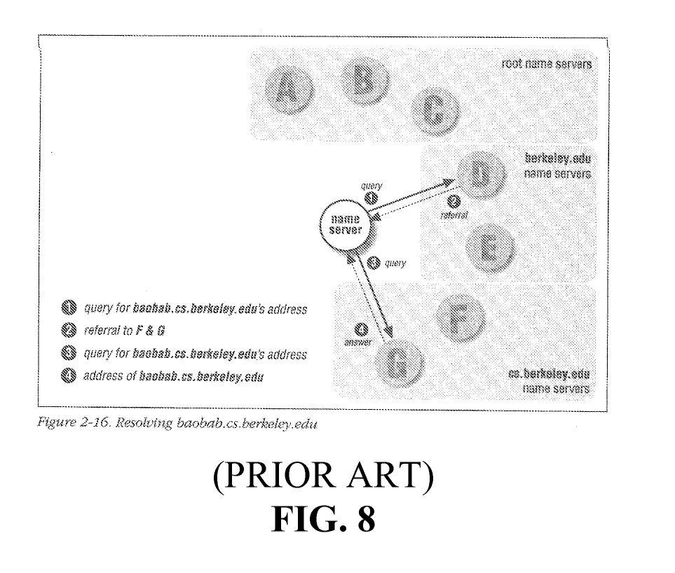

Please refer back to my explanations above, about the RESOLUTION PROCESS, and to FIGS. 6 through 8.

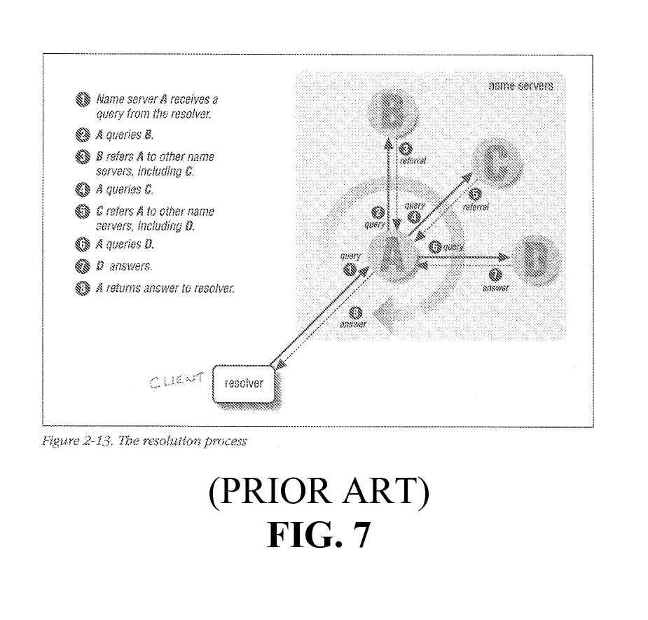

I will explain the process again, using FIG. 7.

The Client/Resolver would represent Mr. Picasso. Mr. Picasso's host computer would query A, which would query B, C, and D, where D would represent UC Berkeley, and would ultimately receive an answer from D saying that this aeinstein@berkeley.edu is invalid.

Notice the list at the left hand side of FIG. 7. the list summarizes the 8 steps used in this Resolution process.

2. With the XMAIL™ System:

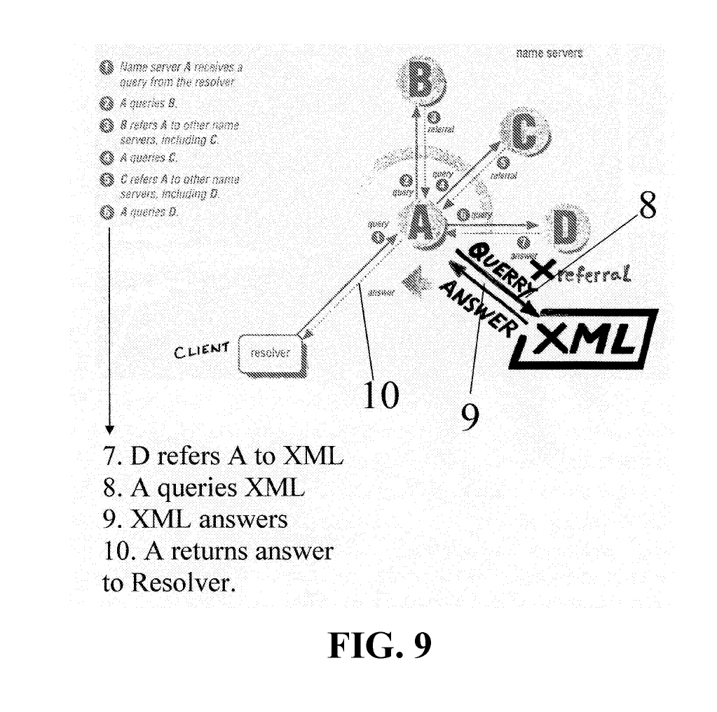

On the other hand, once the XMAIL™ system is adopted and installed and is running on the Internet, in the market, there will be better choices. See FIG. 9.

a) Mr. Einstein could subscribe to our service, as an individual subscriber, and would notify XMAIL™ about his change of address. Then, both the old address and its corresponding new address will be stored in the XMAIL™ database files. XMAIL™ will contact the person at (the owner of) the old address and verify the validity and acceptance of the address change. XMAIL™ could repeat this validation/acceptance check a number of times, at different times, to ensure that the change is for real, before it officially accepts the change and before putting it on the system mainstream.

b) The other way to record the address change with XMAIL™ is that if the authorities at MIT, or the new ISP, or any third party, would do that for Mr. Einstein. MIT could inform XMAIL™ of the change of address of Mr. Einstein. However, in such a case, XMAIL™ will verify directly with Mr. Einstein himself, again more than once, to make sure that the address change is really what Mr. Einstein wants. Only then, will XMAIL™ store the information in its database files and place it in the mainstream of its operation.

So now, once the change of address is entered in the XMAIL™ system, XMAIL™ will start to do its job. If after all that has happened, Mr. Picasso, Sender, sends an email message to Mr. Einstein at his old address “aeinstein@berkeley.edu”, the message will follow the normal route and will arrive at UC Berkeley and will be rejected, the same way as would have happened with the old system. This is represented in FIG. 9 by the path “Client/Resolver-A-B-A-C-A-D-A-Resolver/Client”, exactly as shown also in FIG. 7.

However, here is the improvement.

This is illustrated in FIG. 9.

Please compare FIG. 9 with FIG. 7.

You will notice that the XML has been inserted in FIG. 9 to show that XML is in the system now.

So now, when D, which would be “ucberkely.edu”, determines that “aeinstein@berkeley.edu” is not a valid address, instead of informing A that the address is not valid, D would refer A to XML, step 7 in FIG. 9. Now A will query XML, step 8 in FIG. 9, asking XML to find aeinstein. XML will search in its database files, finds aeinstein's new/present valid address and will send an answer to A, step 9 in FIG. 9, telling A that XML has aeinstein.

So, the difference between FIG. 7 and FIG. 9 is the “two additional steps”, steps 7 and 8 in FIG. 9, where the system interrogates the newly introduced XML node to get a valid address.

Now, A returns his answer, step 10 in FIG. 9, to the Client/Resolver, which then proceeds to send the message to aeinstein.

aeinstein@could be at XML or he could be at@mit.edu or at any other ISP.

To recap.

Because of the added feature provided by XMAIL™ (in SENDMAIL or the like), the system now will generate one additional query. This time, the query will go to XMAIL™, to the XMAIL™ host computer, and will “query” XMAIL™ for an answer relating to this “old” address. XMAIL™ will search/look-up in its data stored in its database files and will extract the “new” address of Mr. Einstein, which is “aeinstein@mit.edu” and inform the system, by giving an “answer” to the system of the new address. This is represented in FIG. 9 by the path “Client/Resolver-A-B-A-C-A-D-A-XML-A-Resolver/Client”. The system will re-route the message to the new address and deliver it to Mr. Einstein, at “aeinstein@mit.edu”.

Logistics

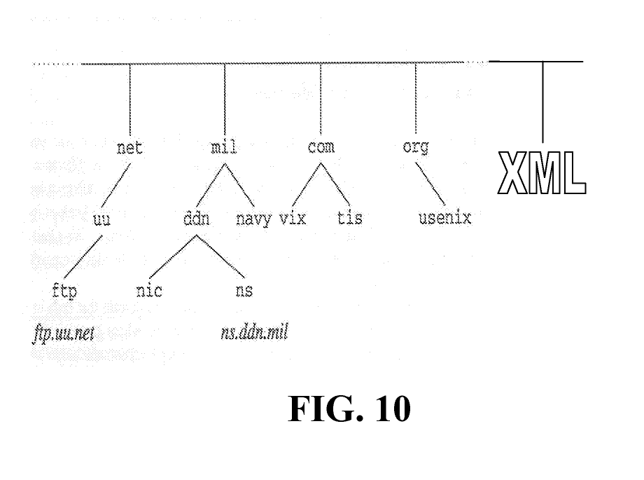

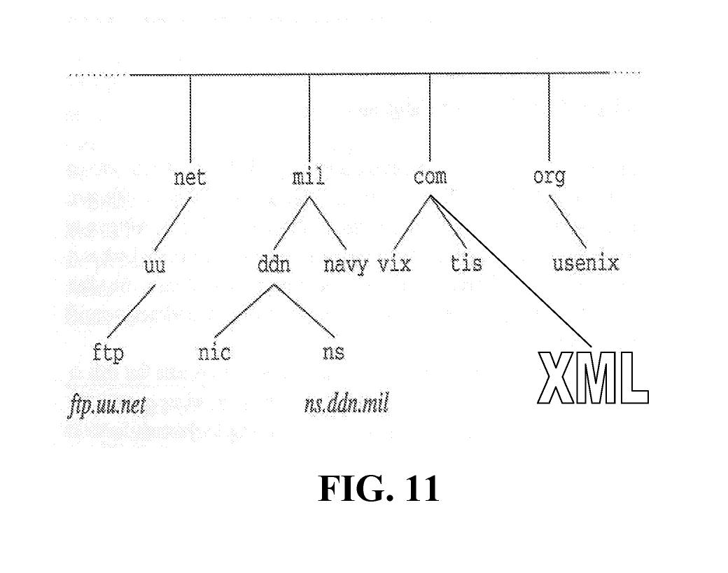

Please see FIGS. 10 and 11.

In order for the above procedure to happen, XML should somehow be hooked up to the Internet already.

One way is shown in FIG. 10. XML could be established as a top level node, directly under the root node of the Internet. So, it will be an “.XML”.

Another way is shown in FIG. 11. In this case, XML could be established as a second level node, say under “.com”. So, it will be called “XML.com”.

Either way, XML per se would be accessible to other name servers and will be able to provide the service explained here.

In addition, if Mr. Einstein had selected this option, then the system will inform Mr. Einstein that the re-routing that took place, giving Mr. Einstein the opportunity to inform Mr. Picasso of the address change.

Additional Features:

Regarding notifications, Mr. Einstein would have several options:

1. Mr. Einstein may opt that the system does not inform him about the “re-routing”.

2. Mr. Einstein may instruct the system, to keep his new address confidential, and not to divulge it to any Sender.

3. Mr. Einstein may instruct the system, to keep his new address selectively confidential, and to divulge it only to certain Senders, which Mr. Einstein would list in advance.

4. Mr. Einstein may instruct the system, to keep his new address selectively confidential, and to divulge it to the Sender of a particular message, after viewing the message.

5. Mr. Einstein may instruct the system to inform him about the “re-routing” and to decide what to do in each individual case. For example, he may decide that Mr. Picasso should be notified and be informed about Mr. Einstein's new address, but he may decide that other sender should not be notified of the new address.

In other words, the notification of either the Recipient and/or the Sender would be a selective choice process. A number of variations can be visualized.

Regarding discarding messages, the system may be instructed to selectively discard messages from certain Senders, such as SPAM senders. Here again, there could be a number of variations. The system may discard those SPAM messages without showing them to Mr. Einstein based on his previous instructions, or the system could place those SPAM messages in a special group and identify them as SPAM and would let Mr. Einstein view them first and then delete them at his will. In a way, this would be pretty similar to various methods used by Anti-Spam software, such as Norton Symantec, in handling SPAM.

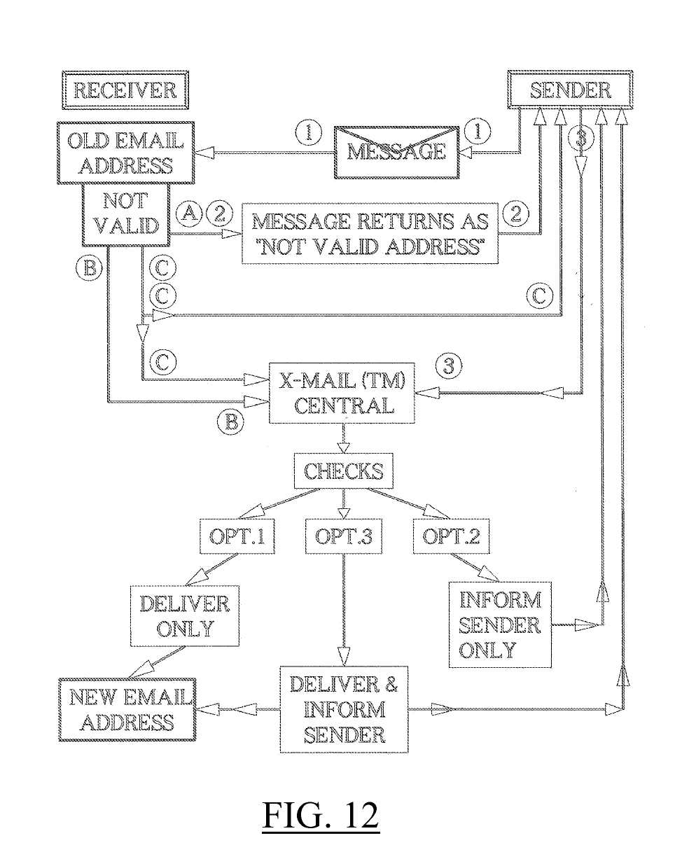

FIG. 12 shows a rough flow chart for some of the process steps described above.

Step 1. The sender uses an old email address of his recipient.

Now there are at least three possible outcomes. Either Step 2 and 2A, or Step 2B, or Step 2C, depending on whether XML is in existence and on the options selected previously with XML.

Step 2 and 2A. The Host Computer of the old address of the recipient returns the message as undeliverable because the address is invalid.

Step 2B. When XML Central is existing and operating, then Host Computer of the old address of the recipient would send the message to XML, or sends a query to XML to find out whether the sender has a new valid address.

Step 2C. When XML Central is existing and operating, then Host Computer of the old address of the recipient would send the message to XML, or sends a query to XML to find out whether the sender has a new valid address.

If Step 2B or Step 2C were selected, then XML would check its database files. If the sender is in the database files, then XML would proceed with one or more of the following steps, again depending on the options selected previously by the participating sender.

Option 1. XML would answer the recipient's Host Computer and would give him the recipient's new valid address and the message will be transferred appropriately to the recipient. XML does not inform the sender of this transaction.

Option 2. XML does not answer the recipient's Host Computer and does not give him the recipient's new valid address. So the message will not be transferred to the recipient. However, XML will inform the sender of the recipient's new address, provided that the recipient had instructed XML to do so.

Option 3. XML does both what is in Options 1 and 2. In other words, XML will answer the recipient's Host Computer and will give him the recipient's new valid address. So the message will be transferred to the recipient. In addition, XML will inform the sender of the recipient's new address, provided that the recipient had instructed XML to do so.

Other options are available, but are not shown in this FIG. 12. Some have been already described earlier. They include the following:

Option 4. XML does not answer the recipient's Host Computer and does not give him the recipient's new valid address. So the message will not be transferred to the recipient. However, XML may keep the message and will inform the recipient that a message was sent by the sender. XML would keep the message, waiting for the recipient to decide what to do with it.

Option 4a. The recipient can decide to view the message first and then either keep it or discard it.

Option 4b. The recipient can decide to view only the name of the sender of the message first and then decide to either view it or not, before deciding to either keep it or discard it.

Option 4c. The recipient can instruct XML to discard those messages right away, without even viewing the message.

Option 4d. The recipient can instruct XML to discard only those messages that came from a certain sender or group of senders, which the recipient had determined previously and informed XML about them. In other words, those senders would be on the “blocked” list.

Many other options are conceivable, regarding the interaction between XML and the participating receiver.

Also several options are conceivable, regarding the interaction between XML and other participating users, if they are the sender themselves.

Furthermore, other options are conceivable regarding the interaction between XML and other Users and Hosts on the Internet.

Example Options:
1. All mail goes directly to XML. In this case, XML would act as the main central HUB.
2. Some Hosts would sing-up with XML and their message traffic would automatically receive the proper support from XML, especially in case of stray messages.
3. Users can sign-up with XML as their main or sole ISP, using a name such as aeinstein@XML.com, for example.
4. Users can sign-up with XML as their secondary/support ISP, using a name such as aeinstein@mit.edu/xml.com, or aeinstein@mit.edu/xml, for example.
5. and so on.

Potential Difficulties:

1-Objections from Old ISP:

In the above example, where Mr. Einstein moves from Berkeley to MIT, there may not be any animosity in the move and Berkeley would cooperate in the proposed scheme of things. However, if the move is from one ISP to another, say from AOL to CompuServe or vice versa, then the old ISP may not be happy about losing the customer to the new ISP. In such a case, the old ISP may try to place roadblocks to undermine the system from operating as intended.

To overcome such potential difficulties, users/customers should request a contractual agreement/promise from their ISP, preferably before signing-up with those ISP, stating that if the customer ever decides to switch, at any time in the future, to another ISP, that their old ISP would cooperate in the transaction of re-routing and forwarding procedure, as per present invention. Possibly, there could be a law enacted to make such behavior automatic and expected.

2-Duplication of Names:

Even if Berkeley decides to cooperate and does not give Mr. Einstein any hard time for moving to MIT, there may be another problem in the way of the system to function properly. Suppose that Mr. Einstein's cousin or distant relative, by a name of Augustus Einstein, decides to join Berkeley. He gets an Internet/Email address at Berkeley and decides to make his email address “aeinstein@berkeley.edu”.

Although the full names of Albert Einstein and Augustus Einstein are obviously different, their “abbreviated” email addresses are identical.

So, if a message is sent to Albert at Berkeley, the Berkeley host computer will automatically deliver the message to Augustus. Of course, Augustus will most probably forward the message to Albert, but this can become a nuisance if it keeps happening repeatedly and too often. Worse things can happen, too. Say, after a while, Augustus gets so annoyed that he does not forward the messages anymore to Albert, and simply deletes them. Then Albert will be cut off from his “lawful” email correspondence.

This example simply illustrates what could happen, if Berkeley allows the use of an “old” email address/name to be used by a new user, other than the first user who selected that address/name in the first place.

So, to prevent such mishaps, it would be advisable and recommended that once a “user-name” or “email address/name” is selected at any “host” location, that other users should never use the same name at any other time afterwards, at least at that same “host” location. An easy way to accomplish this is to add some identifier to names that look alike. For example, if Mr. Albert Einstein was the first user to adopt the name “aeinstein@berkeley.edu”, then any other users with similar user-name, in this case Mr. of Augustus Einstein would have to select a user-name like “aeinstein2@berkeley.edu”, or “aeinstein@berkeley.edu”, or any other user-name which will be different that the one used originally by Mr. Albert Einstein.

This kind of agreement can be something that the Internet Users World could agree to voluntarily, or it may be enacted by law, if the voluntary approach does not get accepted. In essence, this would be similar to the Agreement about the ISP names to avoid duplicities. There could be a similar agreement about individual users names as well.

XMAIL™ will follow such a rule as far as its subscribers are concerned. If Mr. Albert Einstein would be an existing subscriber, with his old email addresses being “aeinstein@berkeley.edu”, and then later on, Mr. Augustus Einstein tries to subscribe to XM with a similar email address as “aeinstein@berkeley.edu”, then XM will have to create a way to differentiate between them, or at least between the messages coming in with this address. This can be done internally, by identifying the two names as #1 and #2 say, and using some inputs and identifying data, from both Mr. Albert and Mr. Augustus and some creative coding from the part of XM. Such identifiers could include the dates of usage of the names,

A world wide “universal” code name could be created, by XML or any other organization, giving every living person or group, an unrepeated identifying number or code, like the telephone numbers, even with the area code and the country code. There would be a huge number of people, but it is still a concrete number. The numbers will still be manageable, if we use a digital format, and include letters, number, etc.

A compromise could be made, say that there should be a moratorium of a number of years, before such a name can be reused. Personally, I do not like such a compromise.

Another proposed method/embodiment is for any and all ISPs to ask XML first, before accepting any request for a new email address, so as to ensure that this new requested email address does not exist in the system already. In other words, XML would become the Repository for ALL email addresses. In a way, it will be doing a similar job for email addresses as ICANN is doing for ISPs. This would ultimately lead to a situation, where XML would be the “center” for issuing all email addresses. This would also lead to what I would call the “Universal Email address for Life” or the “Universal XML Code” or “UXMLC” or simply “XMLC”. We could settle for the term “Universal ID” or “UID”.

Universal User's Name or Universal ID Code

Several schemes can be visualized for such Universal User's Names or Universal ID Codes. I would like to propose some here below.

1. Combine the user's old email name/address with the XML.com ending. For example, if we start with “aeinstein@berkeley.edu”, then the new name would become aeinstein@berkeley.edu.xml.com

1. Combine the user's old email name/address with some add-ons “identifier” to make it unique. For example, use his birth date as the identifier. If we start with “aeinstein@berkeley.edu”, it would become aeinsteinyyyymmdd@berkeley.edu. Not knowing the exact birth date of Mr. Einstein, let's just assume that his birth date is Oct. 21, 1931 say. So his email address would be aeinstein 9311021 @ berkeley.edu.

3. Combine the user's old email name/address with his birth date, but use the numerical value of the date like for the Julian calendar for example. Pursuing the above example, this would then be aeinstein11617@berkeley.edu

4. Combine the user's old email name/address with his birth date and a consecutive number to be assigned by the system, if we expect to have a lot of users by the same name and born on the same birth date. In this case, it could end up being like aeinsteinyyyymmdd###@berkeley.edu. Pursuing the above example, this would then be aeinstein19311021999@berkeley.edu or aeinstein11617@berkeley.edu.

Etc.

These identifiers could be used internally within the XML system or within any similar system. In other words, the visible name in the address does not need to be extremely long. At one time, an ISP was using alphanumeric name for the users. Almost like the telephone numbers. It could be a good idea to revive that method.

1. A system, for salvaging stray email messages on the Internet, comprising
a) a host computer, referred to hereafter as the XMAIL™ Server or simply XMAIL™, to act as a repository center, to store information correlating old “invalid” email addresses, and possibly other contact data, of participating users, hereinafter referred to as the recipients, to their corresponding new “valid” email addresses, in database files, referred to herein after as Master Exchange Database or simply XMAIL™ Database, and
b) a software program and established procedures, which control the handling of the information and the messages on the Internet,
wherein
c) when an email message sent through the Internet system is determined to be addressed to an old invalid address,
d) a query is sent to the Xmail™ Server to obtain the corresponding new valid address,
e) and the system will then use this information to redirect the message in question to its intended recipient at that new valid address.

2. A system, like in claim 1, wherein
said software program and established procedures are already existing on the Internet system, having being put in place by any other third party, except that the step of sending the query to the Xmail™ Server would be added to the existing procedures.

3. A system, like in claim 1, wherein
a program, such as a Mailer Daemon or the like, will send a query to the XMAIL™ Server, to obtain the corresponding new valid address, and to then re-direct the message to that new valid address.

4. A system, like in claim 1, wherein
the system using a program, such as a Mailer Daemon or the like, will deliver the message to the XMAIL™ Server, informing it that the address used with that email message seems to be invalid,
and wherein
the XMAIL™ Server itself will obtain the corresponding new valid address from its own database, and then proceeds to redirect the message to that new valid address.

5. A method for salvaging stray messages on the Internet from being permanently lost or discarded, and for attempting to deliver them to their intended recipients, said method comprising
a) establishing at least one host computer, referred to hereafter as the XMAIL™ Server or simply XMAIL™, to act as a repository center, to store information correlating old “invalid” email addresses, and possibly other contact data, of participating users, hereinafter referred to as the recipients, to their corresponding new “valid” email addresses, in database files, referred to herein after as Master Exchange Database or simply XMAIL™ Database, and
b) establishing procedures, which enables said stray messages to arrive to at least one distribution center,
c) relaying the information between the repository center and the distribution center,
wherein
d) the repository center informs the distribution center about the proper/present valid address of each respective recipient, and then
e) the distribution center handles said stray messages or forwards them to each respective intended recipient.

6. A method as in claim 5, wherein
said repository center and said distribution center are combined into one entity.

7. A method as in claim 5, wherein
said stray messages are email messages and are being handled over the Internet.

8. A method as in claim 5, wherein
said stray messages are letters, parcels, packets and the like and are being handled via the US Postal Service or by Independent Delivery Services, such as FEDEX, UPS or the like.

9. A method as in claim 5, wherein
said stray messages are telephone messages and the users are telephone users.

10. In a system for distributing/transferring email messages over the Internet, said system comprising
a) several servers acting as nodes, wherein
b) when a message is sent on the Internet by a sender to a recipient, the system goes through a series of search steps to locate the message recipient's host computer and attempts to transfer and/or forward said message to its recipient, said search going from one level node to a next level node, until the system finds the message's destination and the message is then delivered to its intended recipient, all this being based on the information contained within the email address of the recipient, and wherein
d) the system would stop the forwarding search procedure and would fail to deliver the message, if the recipient email address at the time of the delivery search process is found to be “invalid”, said message getting returned to the sender as “undeliverable” because “the address is not valid”, thus resulting in that the message would not be delivered to its intended recipient, in which case, such a message would be referred to as a “stray message”, and would ultimately be discarded,
e) the improvement comprising
f) the inclusion in the system and its procedure of a certain improvement for the purpose of salvaging such a stray message from being permanently lost or discarded, and for attempting to deliver it to its proper intended recipient, said certain improvement comprising
g) at least the additional procedure steps, which would take such a search for the undeliverable/stray message destination through a least one additional search step in the procedure, referred to as the “XMAIL™ search and locate” procedure or the “X-Mail” procedure, wherein
h) the system would search and try to locate a substitute “valid” address for said intended recipient, based on data stored in at least one repository center established for such purpose, and
i) once such a substitute valid address is found corresponding to the original invalid address, then
j) to attempt to forward/transfer said message to said substitute valid address and hence to its intended recipient.

11. An improved system as in 10, wherein
an additional node/host computer is added to the conventional system, said additional node will be referred to as the XMAIL™ Server or node, wherein the main purpose of said XMAIL™ node is to act as a Repository Center, to store information correlating old “invalid” email addresses, and possibly other contact data, of participating users, hereinafter referred to as the recipients, to their corresponding new/replacement “valid” email addresses, in database files, referred to herein after as Master Exchange DataBase or simply XMAIL™ Database, so that the XMAIL™ node would inform the system about the new/replacement “valid” email address of the respective recipient and then the stray message would be re-routed to the new replacement valid address and thus would be delivered to its proper intended recipient.

12. An improved system as in 11, wherein
Said X-Mail node would be known in the Internet industry as the place to send all stray messages, for the purpose of salvaging such stray messages from being permanently lost or discarded, and for attempting to deliver them to their proper intended recipients
